(19) United States
(12) Patent Application Publication
(10) Pub. No.: US 2006/0226255 A1
(43) Pub. Date: Oct. 12, 2006

(54) Overflow showerhead assembly

(75) Inventors: Jeffrey A. DeBoer, Ann Arbor, MI (US); Aaron Hughes, San Francisco, CA (US)

Correspondence Address: CARLSON, GASKEY & OLDS, P.C., 400 WEST MAPLE ROAD, SUITE 350, BIRMINGHAM, MI, 48009, US

(73) Assignee: Alsons Corporation

(21) Appl. No.: 11/082,001

(22) Filed: Mar. 16, 2005

(51) Int. Cl. B05B 1/36

(52) U.S. Cl. 239/193; 239/17

(57) ABSTRACT

A showerhead assembly includes a vessel having an upper surface which defines an edge which connects to a lower surface. Water partially flows about the edge and generally focuses the water about the lower surface until the surface tension is overcome and the water falls or breaks from the edge and lower surface to provide a random release of the water onto the bather to provide a significant waterfall effect with a relatively large quantity of water.

### BACKGROUND OF THE INVENTION

The present invention relates to a shower fixture, and more particularly to a showerhead assembly that fills and overflows to provide a waterfall effect.

Oversized luxury showers and accessories are becoming increasing desirable in new construction and bathroom renovations. Such showers typically include one or more multi-function showerheads that have a plurality of spray modes, including various standard sprays and pulsed sprays. Multi-function showerheads may also have flow control valves to allow the user to adjust the flow pressure to a desired level. Other conventional showerheads provide simulated rainfall or waterfall experiences.

Although somewhat effective in providing such simulated experiences conventional rainfall and waterfall showerheads may be lacking in simulating a significantly satisfactory flow of water to simulate being within a rain or waterfall.

Accordingly, it is desirable to provide a showerhead assembly which provides a significantly satisfactory flow of water to simulate being within a rain or water fall.

### SUMMARY OF THE INVENTION

A showerhead assembly according to the present invention includes a vessel having an upper surface includes a concave area which may be at least partially filled with water from a water supply conduit. An edge includes a radius such that the overflowing water adheres thereto through surface tension. The water partially flows about the edge and onto a lower surface which is convex in shape. The convex shape generally focuses the water about the lower surface until the surface tension is overcome and the water falls or breaks from the edge and lower surface to provide a random release of the water onto the bather to provide a significant water fall effect with a relatively large quantity of water.

The present invention therefore provides a showerhead assembly which provides a significantly satisfactory flow of water to simulate being within a rain or waterfall.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general perspective view an exemplary shower for use with the present invention;

FIG. 2 is an expanded perspective view of a showerhead assembly designed according to the present invention;

FIG. 3 is a perspective view of another showerhead assembly which provides a specific waterfall pattern;

FIG. 4 is a perspective view of another showerhead assembly which provides a specific waterfall pattern;

FIG. 5 is a perspective view of another showerhead assembly which provides a specific waterfall pattern.

FIG. 6A is a side view of another showerhead assembly with a drain aperture; and

FIG. 6B is a side view of another showerhead assembly with a dump aperture.

### DETAILED DESCRIPTION OF THE PREFERRED EMBODIMENT

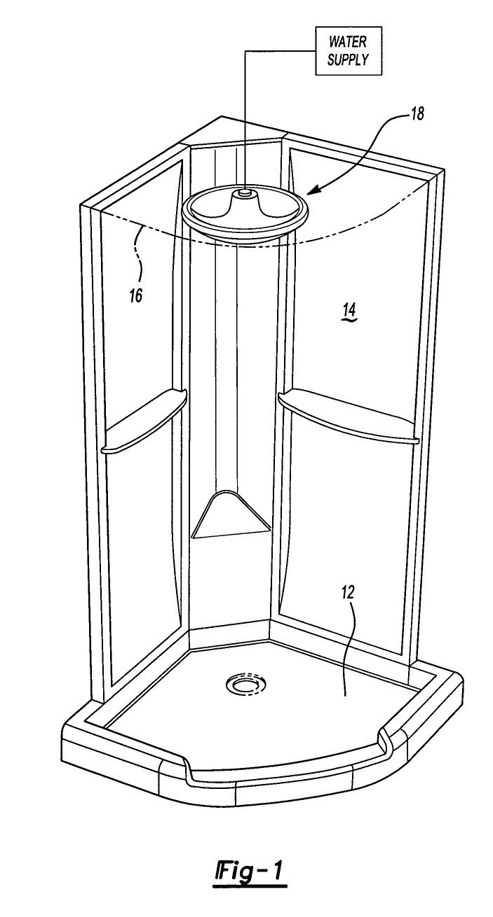

FIG. 1 illustrates a general perspective view of a shower 10. The shower 10 generally includes a base 12, one or more walls 14 and a ceiling 16. It should be understood that the term “base” is not limited to just shower bases but that relatively deeper tubs and the like will also be usable with the present invention. It should be understood that although a particular component arrangement is disclosed in the illustrated embodiment, other arrangements, e.g. molded surround or tiled construction will benefit from the instant invention.

The shower 10 includes a showerhead assembly 18 mounted to the ceiling 16. The showerhead assembly 18 is preferably an overhead fixture that at least partially fills with water and overflows to provide a waterfall effect to the bather.

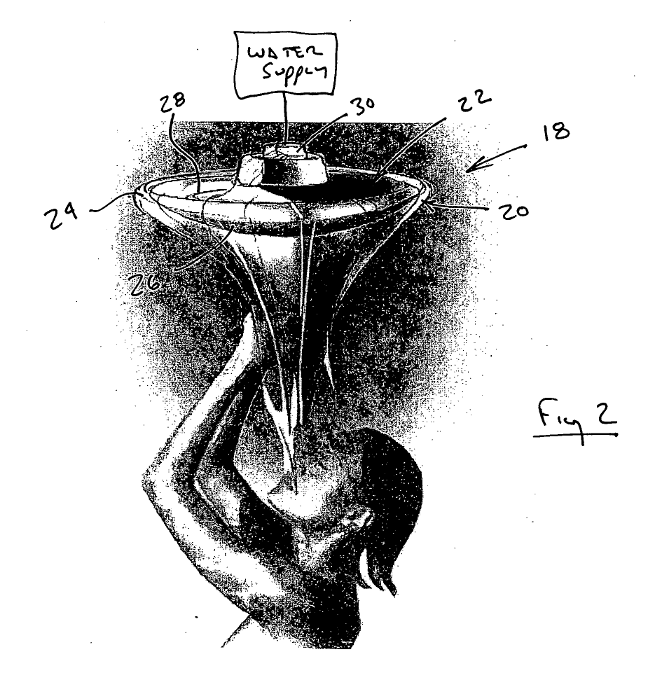

Referring to FIG. 2, the showerhead assembly 18 generally includes a vessel 20 having an upper surface 22 which defines an edge 24 which connects to a lower surface 26. It should be understood that relative positional terms such as “forward,” “aft,” “upper,” “lower,” “above,” “below,” and the like are with reference to the normal operational attitude of the vehicle and should not be considered otherwise limiting.

The upper surface 22 includes a concave area 28 which may be at least partially filled with water from a water supply conduit 30 located toward the center thereof. The concave area 28 is preferably generally annular and surrounds the water supply conduit 30. Notably, the water supply conduit 30 does not pass through the vessel 20 but communicates water thereto such that the concave area 28 fills with water prior to overflow about the edge 24.

“Annular” as used herein is not to be limited to only a circular shape, but is to defined as to generally surround the water supply conduit 30 such that water from the water supply conduit will fill the entire concave area 28. Likewise, the conduit need not be centrally located but need only supply water to the upper surface 22.

The edge 24 includes a radius such that the overflowing water adheres thereto through surface tension. The water partially flows about the edge and onto the lower surface 26 which is preferably convex in shape to form a generally dish or bowl-shaped vessel. The convex shape generally focuses the water about the lower surface 26 until the surface tension is overcome and the water falls or breaks from the edge 24 and lower surface 26. The showerhead assembly 18 provides a random release of the water onto the bather to provide a significant waterfall effect with a relatively large quantity of water.

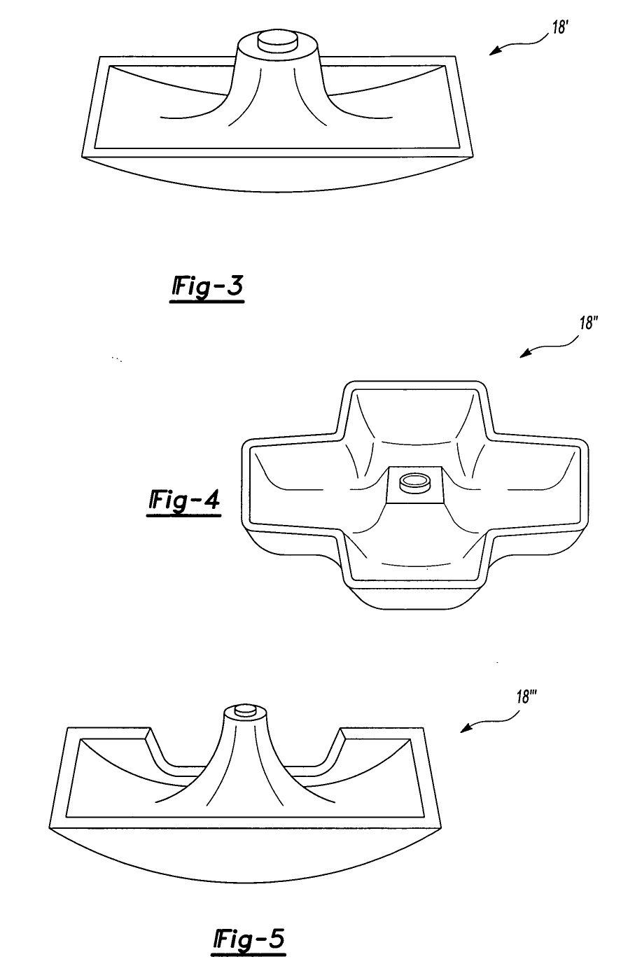

It should be further understood that although the vessel 20 in the illustrative embodiment is generally circular in shape, other edge shapes, such as rectilinear, and or discontinuous shapes (FIGS. 3, 4 and 5) will likewise be useable with the present invention to provide various waterfall patterns.

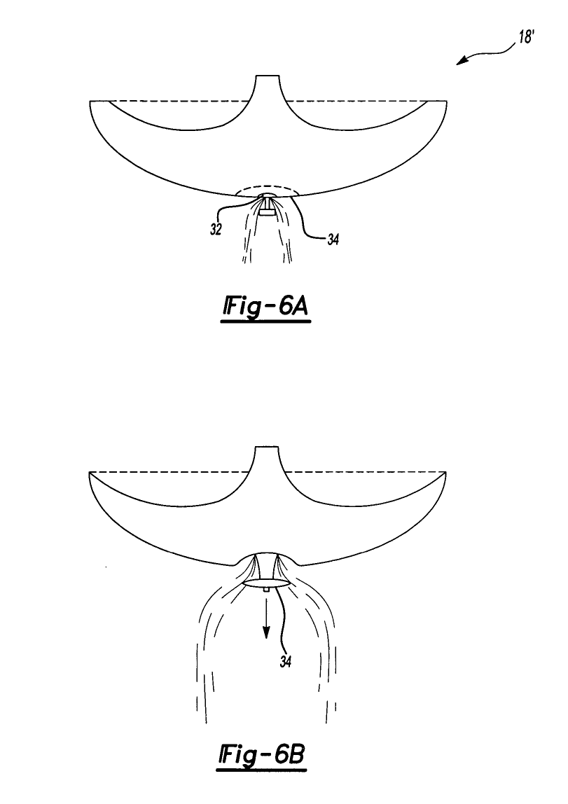

Referring to FIG. 6A, a drainage aperture 32 located in the lower surface 26 of a showerhead assembly 18′ communicates with the concave area 28. The drainage aperture 32 is selectively opened to drain the showerhead assembly 18. The drainage aperture 32 may be opened toward the end of a shower to release water contained within the showerhead assembly 18. Alternatively, or in addition thereto, a dump aperture 34 is selectively opened to prove a relatively large volume dump of water from the concave area 28 (FIG. 6B).

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A showerhead assembly comprising:
a vessel which receives a water flow such that said vessel overflows over an edge of said vessel.

2. The showerhead assembly as recited in claim 1, wherein said vessel is generally dish shaped.

3. The showerhead assembly as recited in claim 1, wherein said vessel includes a concave area.

4. The showerhead assembly as recited in claim 3, wherein said concave area is annular.

5. The showerhead assembly as recited in claim 1, wherein said edge includes a radius to which the water flow at least partially adheres through surface tension.

6. The showerhead assembly as recited in claim 1, wherein said edge connects to a convex surface to which the water flow at least partially adheres through surface tension.

7. A shower comprising:
a shower ceiling;
a vessel having an upper surface which defines an edge said vessel mounted to said shower ceiling; and
a water supply conduit which communicates water to said upper surface such that said vessel overflows over an edge of said vessel.

8. The shower as recited in claim 7, wherein said upper surface includes a concave area which at least partially fills with water.

9. The shower as recited in claim 7, wherein said concave area is annular.

10. The shower as recited in claim 7, wherein said edge connects to a lower surface, said lower surface having a convex surface to which water at least partially adheres through surface tension.

11. The shower as recited in claim 7, wherein said water supply conduit dispenses the water into an annular area of said vessel.

12. A method of showering water comprising the steps of:
(1) at least partially filling a vessel with water such that the water overflows an edge of said vessel to provide a shower of water.

13. A method as recited in claim 12, further comprising the step of:
overflowing the water randomly over the edge.

14. A method as recited in claim 12, further comprising the step of:
at least partially adhering the water to a lower surface of the vessel through water tension.

15. A method as recited in claim 12, further comprising the step of:
at least partially adhering the water to an edge of the vessel through surface tension.

16. A method as recited in claim 12, further comprising the step of:
overflowing the water over the edge such that the water randomly breaks away from a lower surface of the vessel to provide the shower of water.
